(19) United States
(12) Patent Application Publication
(10) Pub. No.: US 2002/0103861 A1
(43) Pub. Date: Aug. 1, 2002

(54) Manipulating fleet devices in an index

(76) Inventors: Susan M. Janz, Eagle, ID (US); Donald J. Gathman, Boise, ID (US); Burton H. Poppenga, Eagle, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 09/773,463

(22) Filed: Jan. 31, 2001

(51) Int. Cl. G06F 15/177; G06F 3/00

(52) U.S. Cl. 709/204; 709/221; 710/19

(57) ABSTRACT

An index is modified by either adding or removing a fleet device. A modification action is discovered for the index. A fleet device is discovered for modification in the index. The modification action is implemented in the index. The modification action is either removal of the fleet device from the index or addition of the fleet device to the index. Removal of the fleet device, capturing final usage data for the fleet device and identifying the fleet device as removed. Addition of the fleet device includes verifying the fleet device has a unique identifier, creating a record for the fleet device in the index, and collecting initial usage data for the fleet device.

### FIELD OF THE INVENTION

This invention relates in general to index modification and, more particularly, to securely modifying an index of fleet devices to add or remove fleet devices from the index.

### BACKGROUND OF THE INVENTION

Data has been collected for many reasons and put to many purposes. It is often desirable to aggregate collected data in order to discern changes. For example, many modern printers record running usage data over the lifetime of the device. This usage data may be accessed periodically to discern how many pages have been printed between access times.

Many conventional data collection and aggregation techniques have included manual collection of data and input of the data into a database. Both manual collection and data entry are time consuming, labor intensive, and prone to human error.

Automated collection and entry techniques have been developed to overcome these shortcomings of manual collection and entry. Automated collection techniques require an index of fleet devices for collection of data. Each of the fleet devices in the index is accessed and the data is collected. Although these conventional automated techniques reduce the time and labor required for data collection and entry, errors still frequently occur. One of the main causes of error in these conventional techniques is the lack of a secure system for adding and removing fleet devices from the index. Improperly added or removed fleet devices may create errors in automated collection and entry of the data.

### SUMMARY OF THE INVENTION

According to principles of the present invention, an index is modified by either adding or removing a fleet device. A modification action is discovered for the index. A fleet device is discovered for modification in the index. The modification action is implemented in the index. The modification action is either removal of the fleet device from the index or addition of the fleet device to the index.

According to further principles of the present invention, removal of the fleet device, capturing final usage data for the fleet device and identifying the fleet device as removed.

According to further principles of the present invention, addition of the fleet device includes verifying the fleet device has a unique identifier, creating a record for the fleet device in the index, and collecting initial usage data for the fleet device.

### DESCRIPTION OF THE DRAWINGS

FIG. 1 is a block diagram representing one embodiment of the system of the present invention for manipulating fleet devices in an index.

FIG. 2 is a flow chart illustrating one embodiment of the method of the present invention for manipulating fleet devices in an index.

### DETAILED DESCRIPTION OF THE INVENTION

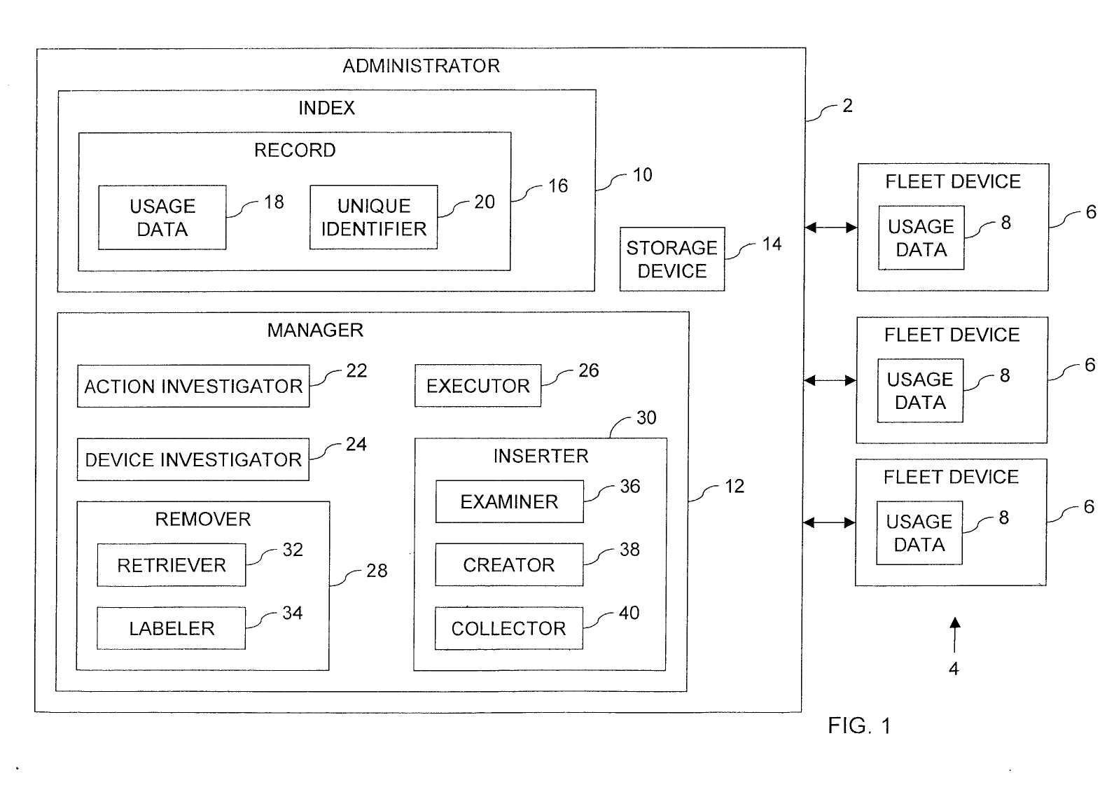

Illustrated in FIG. 1 is a block diagram illustrating an administrator 2 and a fleet 4 of fleet devices 6. Each fleet device 6 is any device able to accumulate usage data 8 and communicate usage data 8 to administrator 2. Examples of fleet devices 6 include printers, scanners, facsimile machines, mopiers, copiers, and multifunction devices. Although FIG. 1 depicts three fleet devices 6 in fleet 4, fleet 4 may include any number of one or more fleet devices 6. For clarity of explanation, only one fleet device 6 will be referred to for the remainder of this description.

Usage data 8 any data accumulated or stored by fleet device 6. Examples of usage data 8 include number of pages processed by fleet device 6, the number of black and white pages processed, and the number of color pages processed.

Administrator 2 includes index 10, manager 12, and, optionally, storage device 14. Although depicted as integral to administrator 2, index 10, manager 12, and storage device 14 are alternatively embodied separate from administrator 2 and accessible by administrator 2. Administrator 2 is any device or system for controlling the administration of index 10.

Index 10 is any index for aggregating data. Examples of index 10 include a database, a spreadsheet, a table, a list and a file. Index 10 includes at least one record 16. Each record 16 represents data from one fleet device 6. Each record 16 includes usage data 18 and a unique identifier 20.

Usage data 18 corresponds to usage data 8 of fleet device 6. Usage data 18 is a copy or aggregation of copies from usage data 8.

Unique identifier 20 is an identification indicia for fleet device 6. Examples of unique identifier 20 include a serial number and a hardware address of fleet device 6. Additionally, other codes may be combined with serial numbers or hardware addresses of fleet device 6 to create unique identifier 20.

Manager 12 is any object, device, or system embodying executable components of administrator 2. Manager 12 may be wholly or partially embodied in executable code. Manager 12 includes action investigator 22, device investigator 24, executor 26, remover 28, and inserter 30. Action investigator 22 is any object, device, system, or combination of executable code configured to discover a modification action for index 10. Likewise, device investigator 24 is any object, device, system, or combination of executable code configured to discover fleet device 6 for modification in index 10.

Executor 26 is any object, device, system, or combination of executable code configured to implement the modification action in index 10.

Remover 28 is any object, device, system, or combination of executable code configured to remove fleet device 6 from index 10. Remover 28 includes retriever 32 and labeler 34. Retriever 32 is any object, device, system, or combination of executable code configured to capture final usage data for the fleet device. Labeler 34 is any object, device, system, or combination of executable code configured to identify the fleet device as removed.

Inserter 30 is any object, device, system, or combination of executable code configured to add fleet device 6 to index 10. Inserter 30 includes examiner 36, creator 38, and collector 40. Examiner 36 is any object, device, system, or combination of executable code configured to verify the fleet device has a unique identifier. Creator 38 is any object, device, system, or combination of executable code configured to create a record for the fleet device in the index. Collector 40 is any object, device, system, or combination of executable code configured to collect initial usage data for the fleet device.

Storage device 14 is any device for storing data or executable code. Storage device 14 may also be a program storage device tangibly embodying a program, applet, or instructions executable by administrator 2 for performing the method steps of the present invention executable by administrator 2. Storage device 14 may be any type of storage media such as magnetic, optical, or electronic storage media.

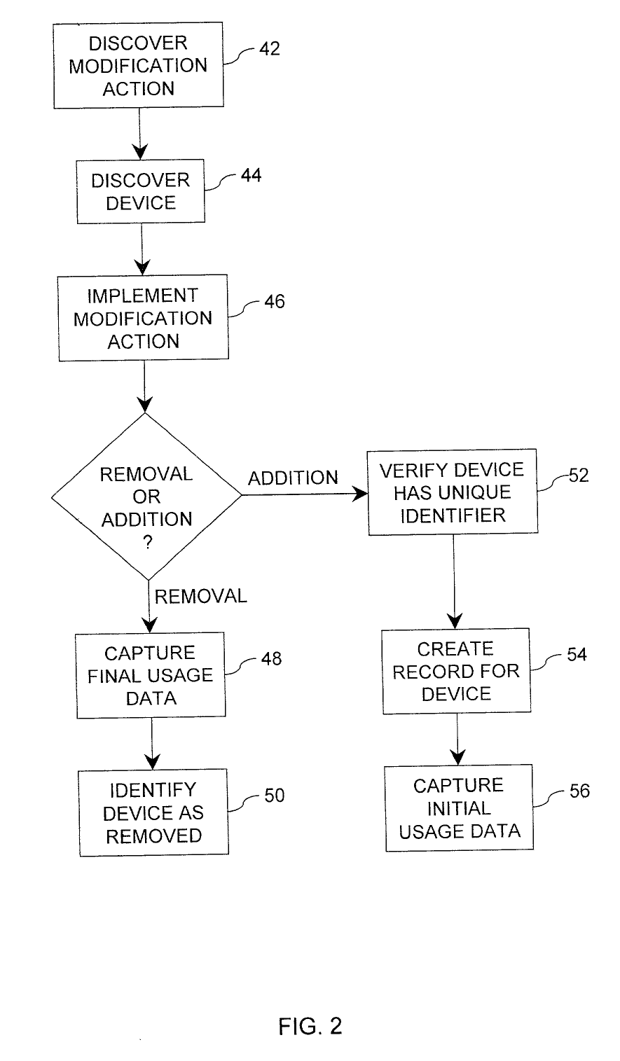

FIG. 2 is a flow chart representing steps of one embodiment of the present invention. Although the steps represented in FIG. 2 are presented in a specific order, the present invention encompasses variations in the order of steps. Furthermore, additional steps may be executed between the steps illustrated in FIG. 2 without departing from the scope of the present invention.

A modification action is discovered 42 for index 10. Examples of modification actions include removing fleet device 6 from index 10 and adding fleet device 6 to index 10. The modification action may be discovered 42 in any manner. For example, the modification action may be discovered 42 by selection from a display, manual entry of a command, or initiation of an object or routine.

A fleet device 6 is discovered 44 for modification in index 10. Fleet device 6 is discovered 44 in any manner. For example, fleet device 6 may be discovered 44 by selection from index 10 or manual entry into index 10.

The modification action is implemented 46 in index 10. The manner of the modification action's implementation 46 depends on the nature of the modification action. If the modification action is a removal of fleet device 6 from index 10, final usage data 8 for fleet device 6 is captured 48 and fleet device 6 is identified 50 as removed. If the modification action is an addition of fleet device 6 to index 10, fleet device 6 is verified 52 to have a unique identifier 20, record 16 is created 54 for fleet device 6 in index 10, and initial usage data 8 is collected 56 for fleet device 6.

The foregoing description is only illustrative of the invention. Various alternatives and modifications can be devised by those skilled in the art without departing from the invention. Accordingly, the present invention embraces all such alternatives, modifications, and variances that fall within the scope of the appended claims.

What is claimed is:

1. A method for modifying an index of fleet devices, the method comprising:
(a) discovering a modification action for the index;
(b) discovering a fleet device for modification in the index; and,
(c) implementing the modification action in the index.

2. The method of claim 1 wherein the modification action includes removal of the fleet device from the index.

3. The method of claim 2 wherein removal of the fleet device includes capturing final usage data for the fleet device.

4. The method of claim 2 wherein removal of the fleet device includes identifying the fleet device as removed.

5. The method of claim 1 wherein the modification action includes addition of the fleet device to the index.

6. The method of claim 5 wherein addition of the fleet device includes verifying the fleet device has a unique identifier.

7. The method of claim 5 wherein addition of the fleet device includes creating a record for the fleet device in the index.

8. The method of claim 5 wherein addition of the fleet device includes collecting initial usage data for the fleet device.

9. A system for modifying an index of fleet devices, the system comprising:
(a) an action investigator configured to discover a modification action for the index;
(b) a device investigator configured to discover a fleet device for modification in the index; and,
(c) an executor configured to implement the modification action in the index.

10. The system of claim 9 wherein the modification action includes removal of the fleet device from the index and further including a remover configured to remove the fleet device from the index.

11. The system of claim 1 0 wherein the remover includes a retriever configured to capture final usage data for the fleet device.

12. The system of claim 10 wherein the remover includes a labeler configured to identify the fleet device as removed.

13. The system of claim 9 wherein the modification action includes addition of the fleet device to the index and further including an inserter configured to add the fleet device to the index.

14. The system of claim 13 wherein the inserter includes an examiner configured to verify the fleet device has a unique identifier.

15. The system of claim 13 wherein the inserter includes a creator configured to create a record for the fleet device in the index.

16. The system of claim 13 wherein the inserter includes a collector configured to collect initial usage data for the fleet device.

17. A program storage device readable by a computer, tangibly embodying a program, applet, or instructions executable by the computer to perform method steps for modifying an index of fleet devices, the method steps comprising:
(a) discovering a modification action for the index;
(b) discovering a fleet device for modification in the index; and,
(c) implementing the modification action in the index.

18. The program storage device of claim 15 wherein the modification action includes removal of the fleet device from the index.

19. The program storage device of claim 15 wherein the modification action includes addition of the fleet device to the index.
